(19) United States
(12) Patent Application Publication
(10) Pub. No.: US 2014/0220517 A1
(43) Pub. Date: Aug. 7, 2014

(54) Apparel-based learning system

(71) Applicant: Michael Bailey, Long Beach, CA (US)

(72) Inventor: Michael Bailey, Long Beach, CA (US)

(21) Appl. No.: 13/987,058

(22) Filed: Jun. 28, 2013

Related U.S. Application Data
(60) Provisional application No. 61/665,854, filed on Jun. 28, 2012.

(51) Int. Cl. G09B 19/04

(52) U.S. Cl. CPC G09B 19/04
USPC 434/167

(57) ABSTRACT

A group of vocabulary words are selected for students at an educational institution. The vocabulary words together with corresponding definitions are put on clothing items worn by different students at the educational institution. The students at the educational institutional are tested regarding the group of vocabulary words and their definitions are before the clothing is worn and some period of days after the clothing started being worn. Selected words from the group of vocabulary words are selected for removal from the group based on the results of the second testing. New clothing items with new vocabulary words together with corresponding definitions are worn by students at the educational institution in place of the clothing items with the word selected for removal from the group.

### CROSS-REFERENCE TO RELATED APPLICATION

This application claims priority to and the benefit of U.S. Provisional Patent Application Ser. No. 61/665,854, filed on Jun. 28, 2012, the entire contents of which are incorporated herein by reference.

### DETAILED DESCRIPTION

A learning system uses shirts for school children (e.g., P. E. uniforms) that each have a vocabulary word and the word's definition on the back. Each shirt has a different word on it or a specific word appears on a limited number of shirts at a particular school. For example, in some embodiments there are 100 words in total, spread over 800 shirts.

The words are chosen from high incidence vocabulary words. More specifically, in some embodiments, the words chosen are taken from studies that prove them the most likely to appear on testing throughout the year, state testing at the end of the year, and essential for school students of a particular age to learn. In some embodiments, the words come from studies that have been conducted showing a significant boost in students' comprehension level of school-based reading materials. In some embodiments, arrangements can be made to include specific words that the participating school would like to focus on.

In order to gauge the effectiveness of the shirts, participating schools are provided with a diagnostic test and answer sheets for the entire student body. At the beginning of the new school year, the students are tested on the vocabulary words on the shirts. This identifies the current English level of each student and the school as a whole. After the test is administered, an analysis is provided to the school identifying the top and bottom performing students, as well as which words the students know, and which words they do not know.

Towards the end of the school year, the same vocabulary test is administered to the student body and an additional analysis is provided to the school. This analysis will show which words the students learned that year and which words they continue to struggle with. The analysis will also show the progress of each student and the school as a whole.

Once the student body shows that they have learned certain words, those words are then replaced the following year with more difficult ones. This is done in order to expand the students' vocabulary and focus on words that the students' do not know.

The system also includes a computer program (e.g., accessible on-line) that tests the students' knowledge of the meaning of the various vocabulary words. The tests may be taken before the shirts are first issued and/or at certain intervals (e.g., every 2 months). The tests are analyzed by the computer program and the shirts with certain words on them are replaced with shirts with a different word according to the analysis. The computer program will identify, for example, words that are known or not know by a certain proportion of students at a particular school and words showing the most or least improvement in knowledge by the student body over are particular time period. These analyses are then used to choose which shirts/words to replace with different shirts/words for the subject school, so that the proportion of shirts with a particular word may be increased or decreased, all shirts with a particular word may be removed, or shirts with a new word are introduced. The analyses may also be used to suggest specific activities or groupings of students. The schools are also provided the results for each specific student for grading purposes or for tracking the progress of individual students.

In some embodiments, the computer program provides results for each class and grade performed individually as well as the school as a whole. In some embodiments the computer program provides the school with analysis showing which words were the most known, least known, most improved, least improved, and will provide them basic observation on how they can improve and how they compare to other schools. In some embodiments, the observations on methods on improvements include suggestions such as: Have the students line up in alphabetical order for roll or before playing based on the word on their shirt; Separate into alphabetic grouping based on words on their shirt (i.e. students with A-E on basketball court #1, students with F-K on basketball court #2; and Word of the day—at the beginning of class or during morning announcements the school or teacher says what the word of the day is. During PE class the student finds which classmate has the word and tells their teacher who has the word and what the definition is.

In some embodiments, the computer program determines which students put effort into the exam and which did not. In some embodiments, this determination is made by placing a simple word, such as book or chair, towards the end of the exam. Since every student in upper elementary, middle school, or high school knows the word book, it is safely assumed that if they did not answer that question correctly it is because they were not engaged in taking the test. The computer program then makes these determinations available to the school.

In some embodiments, as an incentive for students to make a strong effort on the tests, a reward is given to students who achieve high scores and/or show the most improvement between two tests. In some embodiments the reward takes the form of a field trip to a local university.

Individual students can access their own results as well. What is written on the shirts is not limited to vocabulary words and definitions, but can be any academic information, such as math terms, concepts, or formulas, grammar (e.g., parts of speech), foreign languages, science terms, and historical figures or dates.

In some embodiments, in addition to, or in place of, the definitions, the phonetic spelling is printed underneath the word. In some embodiments, certain kinds of words are printed in different color ink or on different color shirts to help distinguish them from one another (i.e. verbs are in blue, nouns in red, adjectives in green). In some embodiments, the least known words are printed in red ink rather than the standard color (such as black) in order for them to stand out more. In some embodiments words are placed on the fronts of the shirts in addition to or in place of the words on the backs of the shirts. In some embodiments, the word is placed on the either the front or back of the shirt and the definition is place on the obverse side of the shirt. In some embodiments the part of speech of the word (e.g., adjective, noun, verb, etc.) is places on the sleeve or other part of the shirt.

What is claimed is:

1. A method comprising:
selecting a first plurality of vocabulary words for of students at an educational institution to learn;
having each of the first plurality of vocabulary words, each together with a corresponding definition, affixed to at least one clothing item to be worn by students at the educational institution, resulting in a first plurality of vocabulary bearing clothing items;
having a first plurality of students wear at least one of the first plurality of vocabulary bearing clothing items at the educational institution during a period of days;
testing the knowledge of a second plurality of students at the educational institutional of the first plurality of vocabulary words before the period of days;
testing the knowledge of a second plurality of students at the educational institutional of the first plurality of vocabulary words after the period of days;
selecting a second plurality of vocabulary words based on the testing before and the testing after the period of days; and
having the first plurality of students wear at least one of a second plurality of vocabulary bearing clothing items at the educational institution during a second period of days, the second plurality of vocabulary bearing clothing items having the vocabulary words from the second plurality of vocabulary words.
